(19) United States
(12) Patent Application Publication
(10) Pub. No.: US 2004/0209571 A1
(43) Pub. Date: Oct. 21, 2004

(54) Apparatus for increasing the capacity between transmitters and receivers in short-range wireless networks

(76) Inventor: Atle Saegrov, Trondheim (NO)

Correspondence Address: Finnegan Henderson Farabow, Garrett & Dunner, 1300 I Street NW, Washington, DC, 20005, US

(21) Appl. No.: 10/475,125

(22) PCT Filed: Apr. 19, 2002
(86) PCT No.: PCT/NO02/00148

(30) Foreign Application Priority Data
Apr. 20, 2001 (NO) 2001-1982

(51) Int. Cl. H04B 5/00; H04B 1/10

(52) U.S. Cl. 455/63.1; 455/41.2

(57) ABSTRACT

An apparatus that is employed to increase the data transfer capacity between transmitters and receivers for short-range data communication, particularly for the ISM frequency bands where different transmitters with different modulation and transmission methods operate in the same frequency band. The object is achieved by orienting antenna lobes that provide high antenna amplification towards transmitters and receivers in the local area of the apparatus, with the result that the distance loss between a transmitter and receiver becomes less than the distance loss represented by the lobes oriented away from the apparatus and the inbuilt amplification in the apparatus. In contrast to a normal “repeater” function for increasing a coverage area, the object is particularly achieved of increasing the capacity in an area where there is already a good transmission channel between transmitters and receivers. The various transmitters and receivers are divided into sub-networks that are isolated from one another, and where the connection is broken between transmitters and receivers that do not communicate with one another. By doing this on the physical level, one is independent of a chosen modulation method and transmission protocol. Thus the invention is especially suitable with the ISM frequency band where a countless number of known and unknown modulation methods and protocols may exist.

### TECHNICAL FIELD

The invention relates to wireless communication technology, and particularly an apparatus for use with short-range wireless networks, where a number of radio transmitters/receivers share the same frequency resource, but are not bound by a harmonised use of the frequency band.

In more specific terms the invention relates to an apparatus for increasing the capacity between transmitters and receivers in short-range wireless communication networks such as in the ISM frequency bands, with the object of increasing the traffic capacity between transmitters and receivers with different protocols operating in the same frequency band.

### BACKGROUND OF INVENTION

The use of wireless networks for short-range communication between computer/mobile terminal and a local network is becoming ever more widespread. In this regard, capacity problems are apt to arise due to the fact that a number of radio transmitters/receivers share the same frequency resource. Another requirement is to share frequency resources between equipment employing different standards for communication in the so-called ISM bands (Industrial Scientific Medical band) where one is not bound by frequency plans or modulation methods/protocols. In these networks, therefore, major problems of interference and capacity reduction will sometimes arise as a result of the great density of transmitters and receivers within a small geographical area.

### THE STATE OF THE ART

U.S. Pat. No. 5,642,353 describes equipment for use in a base station in a mobile telephone network, with a view to increasing the capacity and quality of the communication between wireless units in the network.

U.S. Pat. No. 5,917,447 relates to digital signal processing of digitally controlled antenna lobes. A great many multiplication operations are reduced to summing operations by running a logarithmic operation on the signals before processing and an antilogarithmic operation after processing. The actual processing will then be able to be performed as pure additions, thus saving realisation space.

In U.S. Pat. No. 6,181,914 the use is disclosed of two array antennas in a “repeater” function for wireless networks. A set of amplifiers connects two array antennas in such a manner that they provide the same amplification and phase shift, with the result that the phase front's angle of incidence on the receiver antenna is reproduced on the transmitter antenna. This “repeater” configuration can be regarded as a retro-reflexive antenna, except for the fact that the signal is not reflected back to the radio source, but is mirrored. This entails substantial antenna amplification in the direction in which the source is located, without the need for any analysis of the direction. The mirror effect can lead to unwanted effects, especially in environments with many reflecting surfaces in the vicinity. The technique is therefore best suited to applications where the coverage area requires to be increased, and not for applications where capacity increase is desired in areas with normal coverage.

From U.S. Pat. No. 6,137,785 a technique is known comprising a demodulator based on an array antenna to cope with environments with a great deal of interference and poor signal/noise ratio. By demodulating signals from several receivers and combining the modulated signals, an increased signal/noise ratio is obtained and redundancy, which suppresses interference in the area. A drawback with this technique is that it is intended for a specific communication system, presumably with a given protocol.

None of the above-mentioned publications can be seen to describe or indicate an apparatus, which can be installed independently among operative, wireless units forming part of a network, especially a network where the communication between groups of wireless units is conducted with different protocols, and which automatically leads to a capacity increase for the wireless units involved in the network.

### SUMMARY OF THE INVENTION

It is an object of the present invention to provide an apparatus, which can be installed in an area where wireless communication takes place between wireless nodes in a local network, and which provides a substantial capacity increase for the traffic between the various wireless nodes, i.e. transmitters/receivers in the network, by the apparatus establishing wireless channels between the various wireless nodes.

A further object is to provide an apparatus of this kind, which provides a traffic optimisation between the nodes without interfering with existing protocols, modulation forms, antenna types or other measures that involve alteration of the already installed transmitters or receivers in the area. This is vital in order to avoid the costs of such a traffic optimisation becoming too high.

It is a further object to provide an apparatus of this kind, which can split a radio network into radio sub-networks.

Another object of the invention is to provide an apparatus of this kind, which in addition can provide information on the position of the various wireless transmitters/receivers.

The above objects and other advantages are achieved by means of the features that will be apparent in the following independent patent claim 1. Further advantages are achieved by means of the features that will be apparent in the dependent claims.

Additional advantageous aspects of the invention will be apparent from the following description with drawings, which illustrate a non-limiting embodiment of the invention.

### BRIEF DESCRIPTION OF THE DRAWINGS

FIG. 1 is a block diagram of a composite, local wireless network in which the apparatus according to the invention is included.

FIG. 2 is a block diagram illustrating a situation in a local, wireless network in which the invention is not included.

FIG. 3 is a block diagram illustrating the main elements included in the apparatus according to the invention.

FIG. 4 is a block diagram illustrating the part elements in the general complex cross connector included in the apparatus.

FIG. 5 is a block diagram illustrating an element for bi-directional splitting of the signal to the antennas, and which is included in the apparatus.

FIG. 6 is a block diagram illustrating an implementation of a bidirectional splitting of the signal to the antennas, based on digital conversion of the signal, which is included in the apparatus.

### DETAILED DESCRIPTION OF PREFERRED EMBODIMENTS

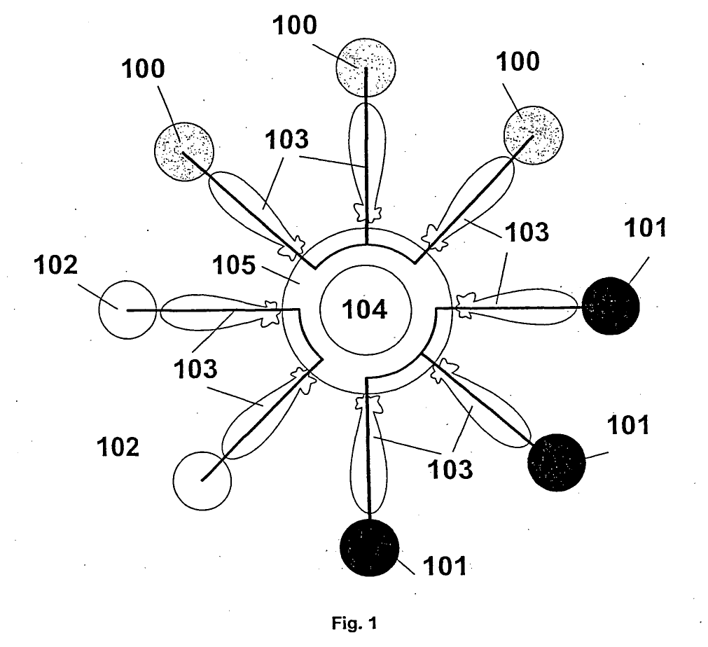

FIG. 1 is a block diagram of a composite, local wireless network in which the apparatus according to the invention is included. It illustrates the object that has to be achieved by the invention and the positions of the system components. A number (illustrated: 8) of nodes 100, 101 and 102 each comprises a transmitter and a receiver operating on the same ISM frequency band. The nodes 100, 101 and 102 are located within a short distance of each other, their positions defining a local area. For example, all the nodes may be located indoors in an office. In the network there are three different implementations of frequency modulation and protocol, where transmitters and receivers 100 employ type A, transmitters and receivers 101 employ type B and transmitters and receivers 102 employ type C. For example, A may represent Bluetooth, B may represent Wireless LAN IEEE 802.11b, while C is an arbitrary protocol, such as a hitherto unknown protocol.

An apparatus according to the invention 105 is installed in the local area defined by the nodes 100, 101, 102. The apparatus 105 is used to analyse the traffic by means of a system controller 104. The system controller 104 then sets up antenna lobes 103, which are directive and directed towards the respective transmitters and receivers in the local area. The system controller 104 then establishes a connection of the signals, which are intercepted by the various lobes 103. High amplification is used of incoming signals, which are intercepted by one lobe and transmitted through a second lobe, with the result that the direct connection between the transmitters and the receivers is masked by the signal path passing through the apparatus 105. The result is that the joint network is broken, and a sub-network is established for transmitters and receivers of the different standards A, B and C. This increases the capacity of the transmitters and receivers in the local area.

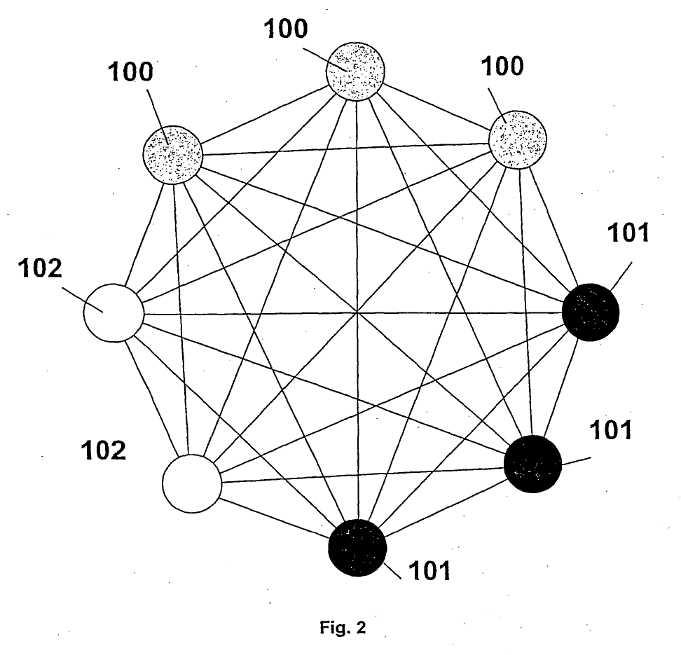

FIG. 2 is a block diagram illustrating a normal situation in a local, wireless network where the invention is not employed. A number (illustrated: 8) of nodes, i.e. transmitters and receivers, 100, 101 and 102 transmit on the same ISM frequency band and are located within a short distance of each other. There are three different implementations of frequency modulation and protocol, where transmitters and receivers 100 employ type A, transmitters and receivers 101 employ type B and transmitters and receivers 102 employ type C. For example, A may represent Bluetooth, B may represent Wireless LAN IEEE 802.11b and C is a hitherto unknown protocol. If transmitters and receivers employ omni-directional antennas, connection will be established between all the nodes in the system. This is normally an advantage with radio systems and broadcasting, but in contexts where substantial traffic capacity is required between the nodes, this is a significant drawback.

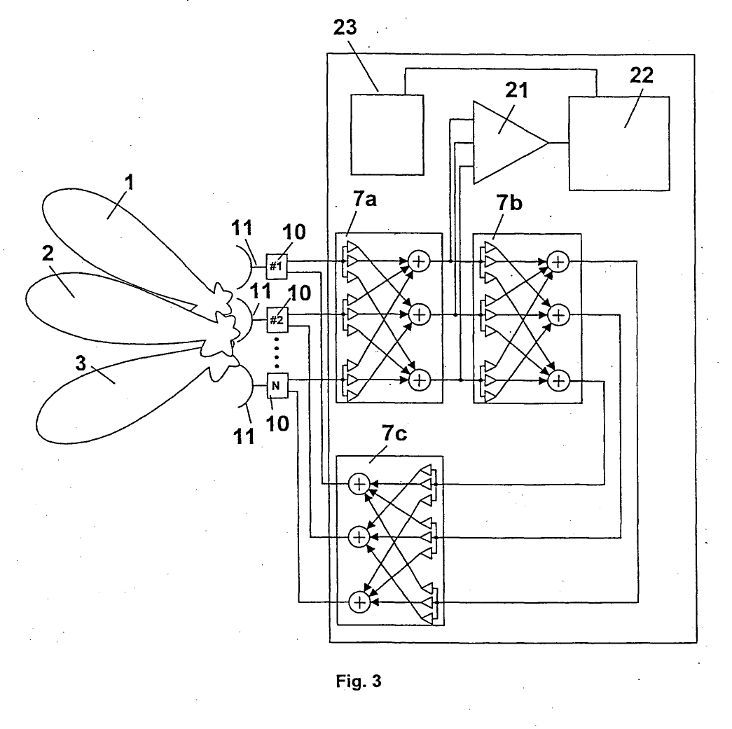

FIG. 3 illustrates an implementation of an apparatus according to the invention. An array antenna with a number n (illustrated: 3) of antennas 11 is arranged in a multidimensional configuration. The signal from each antenna 11 is passed into a signal splitter 10, which directionally splits the antenna signal. The receiver part of the signal is passed into a general complex cross connector 7a, which weighs each of the input signals and sums the complex amplifier factors. After the first cross connector 7a the signals are split into one signal for each of an arbitrary number of receiver lobes—illustrated here by 1, 2 and 3. The signal for the different receiver lobes is passed into a new cross connector 7b that acts as a “switch”, routing the signals in a given connection matrix. “Switches” of this kind are analogous to apparatus known from connection between networks such as Ethernet, where the connection is divided into sub-networks. The signal emitted from the second cross connector 7b is passed into the third cross connector 7c, which acts as a lobe former for the transmitter antennas, where the input signals represent the signal for each of an arbitrary number of transmitter lobes. The signal is then passed into the signal splitters 10 and then to the antennas 11, which are a multidimensional array antenna with a number m of antennas.

An analysis is performed of the signals transmitted through the system by means of the demodulator 21 and the protocol analyser 22. The information from here is fed to the system controller 23. This system controller 23 is arranged to analyse and establish optimal connection between the different transmitters and receivers by setting the parameters in the various cross connectors 7. The system controller 23 is also arranged to sweep the different main lobes for receipt of signals in order to trace radio sources and establish new cross-connected wave channels. The algorithm performed by the system controller 23 also includes an active echo and reflection cancellation, in which a small time delay can be inserted, thus enabling reflections and unwanted connection of a transmitted signal to be analysed by the system controller 23, so that adaptive filters can be inserted to compensate for this. The system controller 23 is also arranged for adaptive control of the amplification of the transmitted signal, thus preventing the occurrence of saturation and generation of unwanted harmonic intermodulation products on the application of strong signals, while at the same time the amplification is strong enough for weak signals to ensure that there is less distance loss through the system of receiver and transmitter lobes than there is by direct distance loss. By digitising the signal from the antennas, the possibility is also offered of transmitting these data through a suitable medium for high-speed transmission, such as a fibre optic cable, thus enabling radio transmitters and receivers to be connected on the physical level over long distances, thereby being independent of chosen protocols in the frequency band concerned. This is particularly applicable for frequency bands such as the ISM bands where countless numbers of future unknown modulation principles may exist.

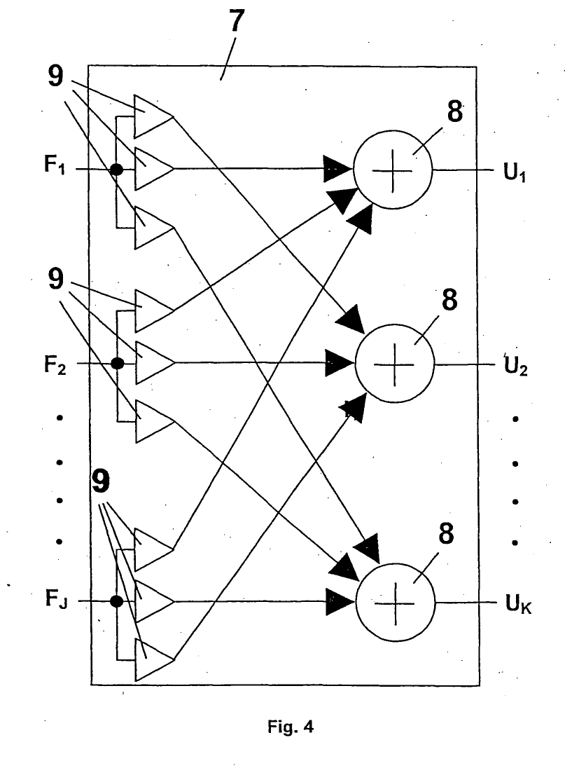

FIG. 4 illustrates the details of the general complex cross connector 7, which is included in the apparatus according to the invention and which is employed as a cross connector 7a, 7b, 7c in FIG. 3. The cross connector 7 has J inputs F₁ . . . ,ⱼ and K outputs U₁ . . . ,_{K}. For each input there are K complex amplifier coefficients 9 that are multiplied by the complex input signal. A contribution from each of the input signals is summed complexly in the summation operation 8 and becomes the output signal. All the coefficients may assume different values. The output signals thereby have the following form

$${U}_{k} ( t ) = {\sum }_{i = 1}^{I} Fi ( t ) \cdot {C}_{ik}$$

where Cᵢₖ is the complex coefficient for output signal k, which is multiplied by the input signal Fᵢ(t) for each of the input signals. The input signals Fᵢ(t) are complex signals, and Cᵢₖ is given in the form

Cᵢₖ=Aᵢₖ·e^{jPik}

where Aᵢₖ is the coefficient for multiplication of the signal's amplitude and Pᵢₖ relates to phase shift of the signal.

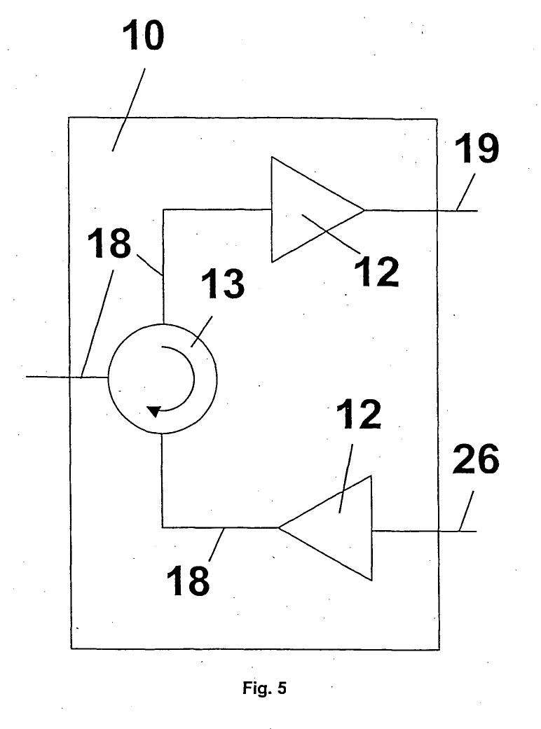

FIG. 5 illustrates a bi-directional splitter that leads signals with different directions into different branches. The radio signal from the antenna is passed through the transmission lines 18 to the circulator 13. The circulator splits the signal in such a manner that the radio signal coming from the antenna is passed to the upper branch with buffer/amplifier 12 on to the other system components through the transmission line 19, while the signal from the other system components is passed through the transmission line 26 to the buffer/amplifier 12 in the lower branch and then to the antenna through the circulator 13. The isolation in a standard circulator between the transmitter and receiver branches is between 20 and 30 dB. A standard “repeater” can thus be realised by connecting two antennas and two signal splitters. In this case, therefore, the amplification on each buffer/amplifier may be between 40 and 60 dB in order to prevent oscillation from occurring. This requires the return loss in each antenna to be more than 20 dB. In the case of reflections where the return loss is less than this, the maximum permitted amplification will be twice this return loss.

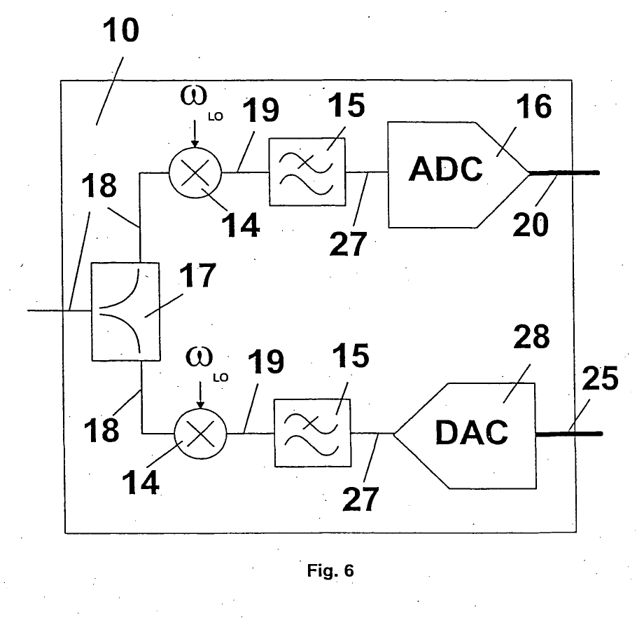

FIG. 6 illustrates a bidirectional splitter, frequency converter and digital converters. The radio signal from the antenna is passed to the splitter 7, which may be a Wilkinson splitter for obtaining isolation between the two branches. The splitter could alternatively be a circulator 13, but a splitter is employed here in order, amongst other things, to reduce the cost of realisation. By using a splitter, 3 dB extra insertion loss is obtained, which means that the amount of noise in the system increases correspondingly. Thus the distance to the radio sources determines this choice. The signal from the antenna is passed through the splitter to the complex mixer 14 in the upper branch through the transmission line 18. The signal is then converted to a frequency that is suitable for digitisation and passed through two transmission lines 19—one for the real signal component (also called the I component) and one for the imaginary signal component (also called the Q component) to a low pass filter before being passed through two transmission lines 27 to the complex analog to digital converter 16, which digitises the signal and passes on the digital words in a first double data bus 20—one data bus for the real component and one data bus for the imaginary component. In the same way the digital word on the second complex data bus 25 comes to a complex digital to analog converter 28, which reconstructs two analog signals—one signal for the real component and one signal for the imaginary component. The signals are passed through two transmission lines 27 to two low pass filters and then to the complex mixer 14, which converts the signals in frequency to the desired frequency. The complex mixer 14 is realised in the same way as for down converting, the local oscillator that feeds the carrier wave frequency ω_{LO} being split into two signals and passed to two mixers where the phase difference between the two oscillator signals on the two mixers is 90 degrees. On the RF side the two signals are added together. It is a point that the mixers that are employed are double-balanced, with the result that the carrier wave of the local oscillator is suppressed as much as possible. It is therefore possible to place the frequency in the local oscillator in the middle of the frequency band concerned and then receive/transmit signals by means of complex modulation in the upper and lower side bands through “digital image rejection”. Another advantage of such a digital implementation of a “repeater” is that a digital echo/oscillation cancellation can be applied, which can compensate for reflections and thus can operate with higher branch amplification than in the analog system.

In the above example the apparatus employs the same antenna elements for receiving and transmission. As an alternative, the apparatus may comprise a first and a second set of antenna elements, where the second set of antenna elements may be placed at a substantial distance from the apparatus. The transfer of antenna signals is conducted through digital high-speed transmission of the digital sampled data from the antennas through a suitable medium such as a fibre optic cable.

In an embodiment the apparatus is arranged to provide data associated with the local position to transmitters and receivers in the area. This is achieved by the system controller 23 being arranged to compute coefficients for lobe forming, based on the local direction vector for incoming signals from transmitters in the vicinity. These coefficients provide the basis for calculating position in the form of a direction vector.

In a special embodiment (not illustrated in the drawings) the apparatus is arranged to actively break the connection between specific nodes in the network, thus acting as access control with a view to data security and quiet zones.

In a special embodiment (not illustrated in the drawings) at least one of the transmitters or receivers operating in the wireless network is included in the apparatus. This is particularly expedient where the apparatus constitutes an access point for a wireless local network.

Several apparatus according to the invention may form a system for increasing capacity between transmitters and receivers in short-range wireless communication networks, such as in the ISM frequency bands, where it is an object to increase the traffic capacity between transmitters and receivers with different protocols operating in the same frequency band. This is achieved by connecting the apparatus wirelessly and establishing links between them, thus forming a local network where traffic is passed between the apparatus through arranged lobes, or through a suitable transmission medium such as a fibre optic cable.

The apparatus according to the invention is particularly suitable for use as a free-standing, independent, wireless extra component for an existing wireless network of communication nodes operating with different protocols in the same frequency band. This application leads to an increased capacity between the existing wireless network nodes, without the need for modifications either of transmitters, receivers or other elements that already form part of the network, either on a physical or higher protocol level.

Those skilled in the art will realise that several possible embodiments and areas of application lie within the scope of the invention, as defined by the features stated in the following claims and by their equivalents.

1. An apparatus for increasing the capacity between transmitters and receivers in short-range wireless communication networks, of for increasing the traffic capacity between transmitters and receivers with protocols operating in the same frequency band, the apparatus comprising a number of antenna elements for transmitting and receiving radio signals, connected to bidirectional splitters for splitting incoming and outgoing directions, connected to complex cross connectors for implementing the forming of transmitter and receiver lobes in addition to cross connecting signals between the various antenna lobes, a demodulator and traffic analyser for monitoring the traffic on the various transmitters in the area and a system controller arranged to make decisions on the basis of the measurements in the traffic analyser and thereby set the various coefficients in the complex cross connectors so that an arbitrary number of transmitter and receiver lobes are electrically connected, thereby guiding traffic between them and thus providing an improvement in capacity for at least one transmission in the area.

2. An apparatus according to claim 1, wherein the apparatus employs the same antenna elements for receiving and transmission, the system controller being arranged to perform an adaptive echo cancellation algorithm that reduces feedback signal from the transmittal signal.

3. An apparatus according to claim 1, wherein the apparatus employs at least a first and a second set of antenna elements, where the second set of antenna elements may be located at a substantial distance from the apparatus, and where the transfer of signals between the antennas is conducted through digital high-speed transmission of the digital sampled data from the antennas through a suitable medium such as a fibre optic cable.

4. An apparatus according to any one of claims 1-3, wherein the apparatus is arranged to operate in an ISM frequency band where the use of several standards for communication is permitted.

5. An apparatus according to any one of claims 1-3, wherein the apparatus is arranged to operate in a frequency band for mobile communication such as GSM or UMTS.

6. An apparatus according to claim 1, wherein the amplification of the signal between a receiver lobe and a transmitter lobe is adjusted adaptively by means of digital multiplication, with the result that the amplification becomes so high that the distance loss between a transmitter and a receiver with omni-directional antennas in an area becomes greater than the distance loss from the respective transmitter and receiver provided through the apparatus

7. An apparatus according to claim 1, wherein the apparatus is further arranged to be employed for indicating local position of transmitters and receivers in the area, the system controller being arranged to compute coefficients for lobe forming based on the local direction vector for incoming signals from transmitters in the vicinity, and these coefficients therefore provide the basis for calculating the position in the form of a direction vector.

8. An apparatus according to claim 1, wherein it is arranged to actively break the connection between nodes in the network's connection to other nodes, thus acting as access control with a view to data security and quiet zones.

9. An apparatus according to claim 1, wherein the apparatus is arranged to be connected to another, corresponding apparatus and to establish links between the apparatus, thereby implementing a local network where traffic is guided between the apparatus through arranged lobes or through a suitable transmission medium

10. An apparatus according to claim 1, wherein at least one of the transmitters or receivers in the network is included in the apparatus.

11. A system for increasing the capacity between transmitters and receivers in short-range wireless communication networks for increasing the traffic capacity between transmitters and receivers with different protocols operating in the same frequency band, comprising a number of apparatus according to claim 1, where the apparatus can be interconnected and establish links between each other, thus implementing a local network where traffic is guided between the apparatus through arranged lobes or through a suitable transmission

12. (Cancelled).
